(19) United States
(12) Patent Application Publication
(10) Pub. No.: US 2024/0028372 A1
(43) Pub. Date: Jan. 25, 2024

(54) PREVENTING UNNECESSARY REGISTRATION OF VIRTUAL MACHINES

(71) Applicant: VMWARE, INC., Palo Alto, CA (US)

(72) Inventors: MANDAR NANIVADEKAR, Pune (IN); LEENA SHUKLENDU SOMAN, Pune (IN)

(21) Appl. No.: 17/964,955

(22) Filed: Oct. 13, 2022

(30) Foreign Application Priority Data
Jul. 20, 2022 (IN) 202241041631

(51) Int. Cl. G06F 9/455

(52) U.S. Cl. CPC G06F 9/45558; G06F 2009/45562

(57) ABSTRACT

Systems and methods are provided for efficiently registering cloned VMs while preventing unnecessary subsequent registrations. Two independent threads can execute on a cloned VM and control different variables indicating whether registration is needed or has already been performed. A first thread can set a first variable based on an internal identifier of the cloned VM relative to the parent VM. It can also check a second variable, set by a second thread, based on an external identifier of the cloned VM not being updated at a backend cloud service. It can then set a third variable indicating whether registration has been triggered or not, based on the other variables. To avoid duplication, the second thread sets the second variable based on both the external identifier as well as a status of the first variable. The variables can be atomic variables to avoid multi-thread interference and undesirable thread locks.

### RELATED APPLICATIONS

Benefit is claimed under 35 U.S.C. 119(a)-(d) to Foreign Application Serial No. 202241041631 filed in India entitled “PREVENTING UNNECESSARY REGISTRATION OF VIRTUAL MACHINES”, on Jul. 20, 2022, by VMware, Inc., which is herein incorporated in its entirety by reference for all purposes.

### BACKGROUND

Virtual machines (“VMs”) are used throughout many industries to provide virtualized computing that provide the functionality of a physical computer. Cloud computing, for example, relies on virtualization to provide VMs for customers that are located remotely from the underlying physical servers that support those VMs. Cloud service providers typically maintain a “pool” of available VMs for a customer and can instantiate more VMs or terminate VMs as customer demand fluctuates. The process of instantiating and terminating VMs generally happens in any scenario that utilizes virtualized computing and is not limited to cloud providers.

Setting up a newly instantiated VM can be a time-consuming process. One solution is to clone an existing VM. This creates a new VM based on an already existing VM, where the new VM inherits the state of the old VM, including all applications, settings, and processes of the old VM. In some examples, a provider can clone a VM running a “golden image,” which refers to a serialized copy of the entire state of a VM that the provider determines is in the desired state. This can include having a specific operating system (“OS”), hardware configuration, patches, and applications. Golden images are useful in that they can be configured to adhere to corporate security and compliance requirements, ensuring that each VM incorporates the same requirements.

An instant clone is a VM created from a golden image and provided for temporary use. After use, the VM can be destroyed. Each of these clones operates as a separate VM based on the golden image. Some products, such as virtual desktop interface (“VDI”) products, allow thousands of clones for a single instance of virtualized management software. In these scenarios, VMs can be instantiated and terminated rapidly, requiring frequent registrations as new VMs are instantiated.

When cloning a VM, problems arise with respect to registering the new VM with the relevant backend system. For example, each VM needs to register as a separate VM in order to differentiate it from another VM, such as the VM used for the cloning process. Because all settings are inherited by an instant clone, the resulting new VM would need to register with the backend system to identify itself as a new VM and obtain an identity specific to that new VM.

Currently, this problem is addressed by detecting triggers indicating that a VM is a clone, causing the VM to register with the backend system. Multiple triggers exist that could indicate a cloned VM, some of which can occur at different times. Examples include changes in the basic input/output system (“BIOS”) universally unique identifier (“UUID”), media access control (“MAC”) address, external identifier such as VM UUID, and other VDI-provider-specific parameters. The multiple triggers can occur at different times and are not aware of one another, potentially causing multiple unnecessary re-registrations with the backend system. Each registration process can take from a few seconds to a few minutes, which is substantial in computing terms—particularly with a large-scale deployment.

Each registration event uses precious computing and networking resources. For an enterprise running thousands of VMs at any given time, multiple unnecessary registrations are a waste of time, energy, and money. Additionally, each re-registration changes the VM's identity and makes it difficult to track historical events. As a result, a need exists for systems and methods for efficiently registering new VMs while preventing unnecessary subsequent registrations.

### SUMMARY

Examples described herein include systems and methods for efficiently registering cloned VMs while preventing unnecessary subsequent registrations. An example method can include instantiating a VM by cloning an existing VM, either as a full clone or an instant clone. Various threads can execute on the cloned VM to perform different tasks related to registration of the cloned VM (also referred to as a “new VM” herein). The threads can be executed by a security application installed on the VM, or by other software executing on the VM.

The first thread can initialize up to three atomic variables, including (1) a first variable associated with an internal identifier of the cloned VM relative to a persisted internal identifier of the cloned VM, (2) a second variable associated with an external identifier of the cloned VM, and (3) a third variable associated with registering the cloned VM with a backend system. These variables are referred to as atomic variables because they can only be accessed or modified by a single thread at a time, avoiding multi-thread interference or redundancies. These variables are interlocked, such that when one thread is accessing a variable, the other thread is barred from execution for that instant but is not put to sleep. The variables are lightweight compared to the use of locks, which may cause the thread to go into a sleep state. The variables can correspond to flags or counters that persist on the VM and at least provide a binary option such as “0” or “1,” or “true” or “false.” The third variable is optional in most examples but is described throughout this disclosure for clarity and thoroughness. However, nothing in this disclosure should be interpreted to require the third variable, as described in more detail later.

The first variable associated with an internal identifier can correspond to internal identifiers such as a BIOS UUID or a MAC address associated with the cloned VM. The second variable associated with an external identifier can correspond to an identifier stored at a backend system or assigned by a hypervisor that controls aspects of the VM. Examples of an external identifier include a VM UUID or a platform UUID. A platform UUID is a UUID assigned by a control plane of a platform for managing VMs, such as VMWARE's VSPHERE platform. The third variable can correspond to whether the cloned VM has been registered with the cloud backend. The states of these variables can persist on the VM and be maintained during a cloning process, such that the cloned VM inherits the variable states from its parent VM.

The first thread can determine whether the internal identifier of the cloned VM is the same as a persisted internal identifier of the cloned VM, or whether the two values are different, indicating that the internal identifier has been changed since the cloned VM was instantiated. Because a cloned VM can begin with the parent VM's internal identifier in persistent storage but eventually receives a unique internal identifier—such as after a reboot—a determination that the internal identifiers are different can indicate that registration has not yet taken place. In that example, the first thread can set the first variable to indicate that the registration process has been triggered based on the internal identifier. The first thread can then cause the cloned VM to register with the backend system. After registration, the first thread can clean up the flags of the variables by setting the third variable to indicate that registration has occurred and resetting the first variable to indicate that registration has not been triggered, such that a subsequently cloned VM would inherit that state.

In an example where the first thread determines that the internal identifier of the cloned VM has not changed, the first thread can check the second variable to determine whether registration has been triggered based on an external identifier of the cloned VM. The state of the second variable can be controlled by a separate thread, as described below. But the first thread can check the state of the second variable by asserting a signal on a memory bus. If the second variable indicates that the external identifier of the cloned VM has not changed, the first thread can end its process. The first thread can run periodically to capture future changes or cloning events.

If, on the other hand, the second variable indicates that the external identifier of the cloned VM has changed, then the first thread can initiate registration of the cloned VM. After registration, the first thread can clean up the flags of the variables by setting the third variable to indicate that registration has occurred and resetting the first variable to indicate that registration has not been triggered, such that a subsequently cloned VM would inherit that state.

As mentioned, a second thread can execute concurrently with the first thread on the cloned VM. In some examples, the second thread is a task that listens for a type of event. For example, the event can be a connection, or reconnection, between the relevant VM and a control plane of a virtualization platform. For example, when a VM is cloned, a connection between the cloned VM and the platform must be established. This connection event can trigger the second thread to perform tasks. For example, the second thread can query a control plane of a management platform to request one or more external identifiers for the cloned VM. The second thread can compare the received external identifiers to corresponding external identifiers stored at the VM or the backend system. If they are different, this indicates that the cloned VM needs to be registered.

However, in order to avoid multiple registrations, the second thread can first check a status of the first variable, which is controlled by the first thread. If the first variable is already set to indicate that registration has been triggered by internal identifiers, the second thread can set the second variable to indicate that registration has not been triggered by external variables. Otherwise, multiple registrations could result. If instead the first variable is set to indicate that registration has not been triggered by internal identifiers, then the second thread can set the second variable to indicate that registration has been triggered by external variables. This way, when the first thread checks the second variable, it will capture information about external variable changes and trigger registration as necessary. The second variable can be reset later as part of the post-registration flag cleanup.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for efficiently registering a cloned VM.

FIG. 2 is a more detailed partial flowchart of an example method for efficiently registering a cloned VM.

FIG. 2 CONT'D includes the remaining portions of the flowchart of FIG. 2.

FIG. 3 is an illustration of a system for efficiently registering a cloned VM.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are provided for efficiently registering cloned VMs while preventing unnecessary subsequent registrations. Two independent threads can execute on a cloned VM and control different variables indicating whether registration is needed or has already been performed. A first thread can set a first variable based on an internal identifier of the cloned VM having changed. If the internal identifier does not indicate a need for registration, the first thread can check a second variable, set by a second thread, based on an external identifier of the cloned VM being changed. It can then optionally set a third variable indicating whether registration has been triggered or not based on the other two variables, which can be useful for reporting or logging functions. To avoid duplication, the second thread sets the second variable based on both the external identifier as well as a status of the first variable. That is, the second thread checks the external identifier as well as a state of the first variable before determining how to set the second variable. The variables can be atomic variables to avoid multi-thread interference and undesirable thread locks.

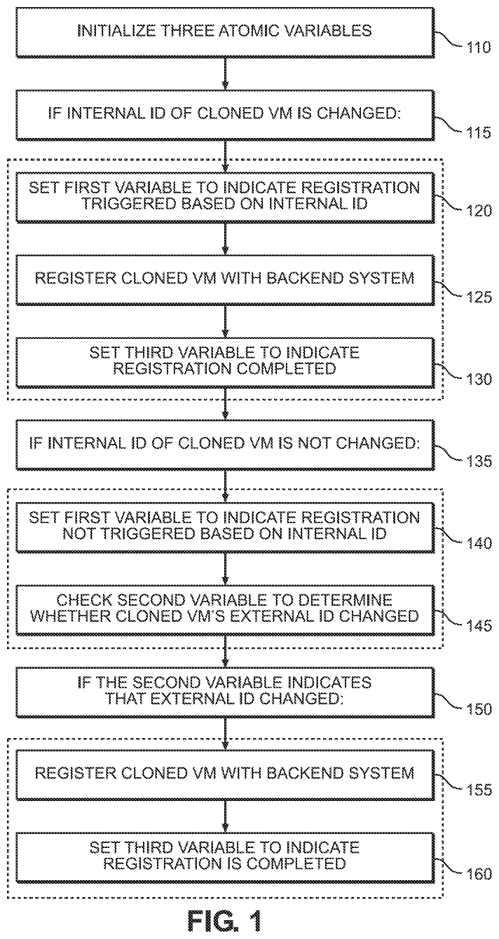

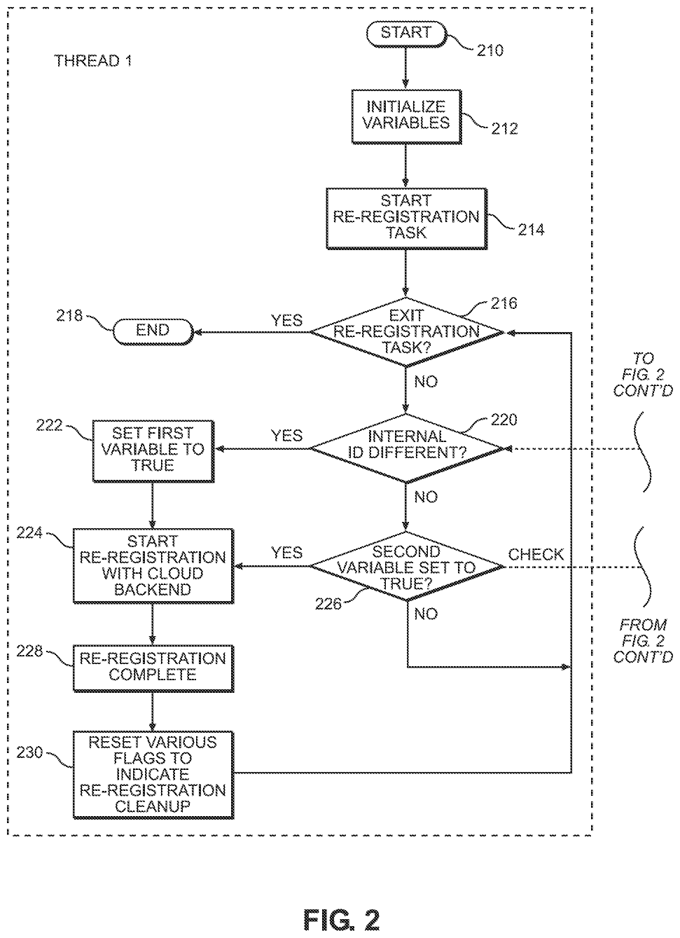

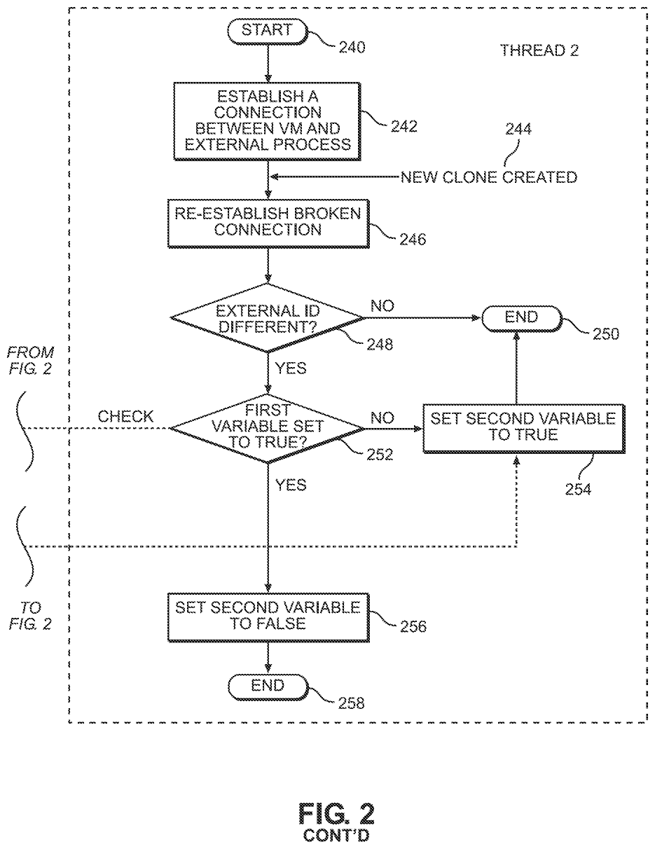

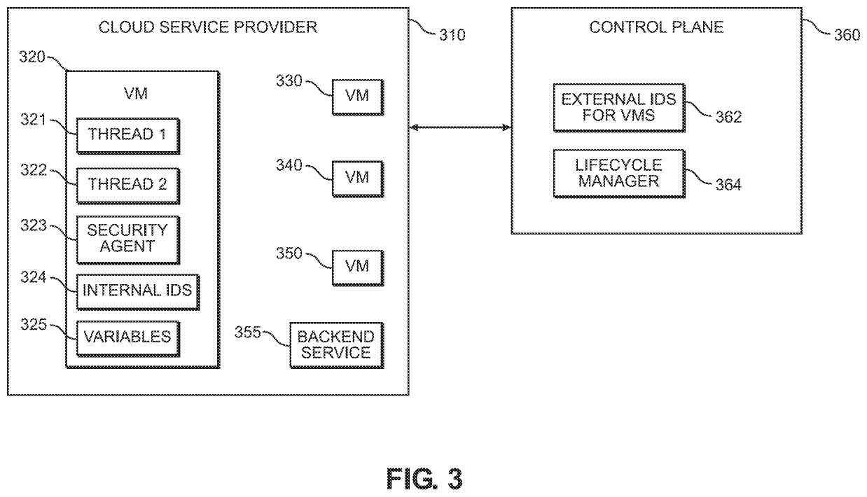

FIG. 1 provides a flowchart of an example method as performed by the first thread. FIG. 2 provides a more detailed flowchart showing steps performed by independent first and second threads as well as variable checks performed between the threads. FIG. 3 provides a system diagram of a system for performing the disclosed methods.

Turning to FIG. 1, a flowchart is shown with various stages, some of which are encompassed within a dashed-line box. The dashed-line boxes indicate groupings of stages that occur in response to a previous determination, as explained in more detail below. At stage 110, three atomic variables can be initialized. In some examples, these variables are initialized by being inherited from a parent VM, such that the variables and their associated states are copied from a parent VM to a cloned VM, such as by storing the variable in persistent storage. But they can also be initialized by being defined or set by a first thread executing on the cloned VM. As used herein, the term “thread” refers to a thread of execution of programmed instructions.

The variables initialized at stage 110 can include, for example, (1) a first variable associated with a current internal identifier of the cloned VM relative to a persistently stored internal identifier of the cloned VM, (2) a second variable associated with an external identifier of the cloned VM, and (3) a third variable associated with registering the cloned VM with a backend system. These variables are referred to as atomic variables because they can only be accessed or modified by a single thread at a time, avoiding multi-thread interference or redundancies. The variables can correspond to flags or counters that persist on the VM and at least provide a binary option such as “0” or “1,” or “true” or “false.”

Although the flowchart of FIG. 1 describes three atomic variables, the third variable described below is optional and can be omitted without sacrificing core functionality of the method. However, the third variable can be useful for reporting or logging purposes and is therefore described in this example. As discussed in more detail below, the method of FIG. 1 is driven by the first and second variables, which overrule the third variable in the event of conflict.

In more detail, the first variable associated with an internal identifier can correspond to internal identifiers such as a BIOS UUID or a MAC address associated with the cloned VM. In some examples, the internal identifier corresponds to both the BIOS UUID and the MAC address. When a VM is instantly cloned, the new clone VM can retain one or more of the parent VM's internal identifiers for a period of time or before an event such as a reboot. A difference between the persistently stored internal identifier and current internal identifier can indicate that a VM is a clone. The first variable can indicate whether the new VM has been registered based on the internal identifier change.

The first variable can be named, for example, “s_bVAIRegTriggeredByBIOS,” “s_bVAIRegTriggeredByMAC,” or “s_bVAIRegTriggeredByIntID.” These example variable names are exemplary and need not be used specifically. The variable can provide at least a binary option that can be set by one or more threads, such as “0” or “1,” or “true” or “false.” In the case of the first variable, the binary option can indicate that registration has been triggered based on at least one of the internal identifiers (such as a BIOS UUID or MAC address) having been changed between the persistently stored internal identifier(s) and current internal identifier(s).

The second variable associated with an external identifier of the cloned VM can correspond to external identifiers such as a VM UUID or platform UUID. A VM UUID can be a unique ID assigned to a VM by an entity outside the VM itself, such as by a hypervisor. A platform UUID can be a UUID assigned by a control plane of a platform for managing VMs, such as VMWARE's VSPHERE platform. In some examples, a VM UUID and a platform UUID are the same thing, but in other examples the two ID types can be different from one another. These IDs, individually or collectively, are referred to herein as an external identifier. A VM can persistently store an external identifier assigned during registration. A new VM cloned from that VM would then inherent the persistently stored external identifier. However, a platform or control plane can assign a new external identifier to the cloned VM, indicating that the cloned VM is a different VM than the parent. When the new external identifier of a cloned VM is different than the stored external identifier, this can indicate a need for the cloned VM to be registered.

The second variable can be named, for example, “s_bVMExtIDChanged” or “s_bVMItegTriggeredByExtID,” which are exemplary names and need not be used specifically. The variable can provide at least a binary option that can be set by one or more threads, such as “0” or “1,” or “true” or “false.” In the case of the second variable, the binary option can indicate that the external identifier has changed. In some examples, the binary option indicates that the external identifier has changed and also that registration has not been triggered by the first variable. In that example, the option indicates that registration is being triggered by the second variable, as described in more detail below.

The third variable can indicate that the clone VM has been registered with a backend system. For example, the first and second variables can trigger registration with the backend system. The third variable can then be set to indicate that this registration process has occurred. This can be useful for logging or reporting, such as by triggering a report to a control plane that registration has occurred. As mentioned above, the third variable is optional because it is not necessarily determinative. For example, if a cloned VM is registered and the third variable is set accordingly, but a new VM is forked from that cloned VM, the new VM can inherit the state of the third variable. In this example, the third variable will incorrectly indicate that the new VM has been registered even when it has not. For this reason, the third variable can be overruled by the first or second variables, making the third variable optional. In another example, when the process detects that the VM is a clone, the third variable can be reset such that it remains correct.

The third variable can be named, for example, “s_bVMRegistered” or “s_bVMReRegistered,” which are exemplary names and need not be used specifically. The variable can provide at least a binary option that can be set by one or more threads, such as “0” or “1,” or “true” or “false.” In the case of the third variable, the binary option can indicate that the VM has been registered or re-registered.

At stage 115, the first thread can determine whether an internal identifier of the cloned VM is changed. This can include, for example, comparing a current BIOS UUID to a BIOS UUID persistently stored in memory associated with the VM. Similarly, this can include comparing a current MAC address to a MAC address in persistent storage. In some examples, this stage includes comparing both of the current BIOS UUID and MAC address to a persistently stored BIOS UUID and MAC address. Stage 115 includes determining that either of these internal IDs have changed, causing the method to proceed to stages 120-130. On the other hand, if the first thread decides that the internal IDs have not changed, the method can skip to stage 135. In an example where the comparison is to both the BIOS UUID and MAC address, stage 115 includes determining that both of these internal IDs have changed.

In an instance where an internal identifier of the cloned VM has changed, the first thread can proceed to stage 120. At stage 120, the first thread can set the first variable to indicate that registration has been triggered based on an internal identifier change, such as by setting the variable to “1” or “true.” For example, the first thread can set s_bVMRegTriggeredByIntID=TRUE. At stage 125, the first thread can register the cloned VM with a backend system. The registration process can include registering the cloned VM with a backend service of a cloud service provider using known methods. After registration, the first thread can optionally perform stage 130, which includes setting the third variable to indicate that registration has been completed. This flag can be useful for logging or reporting registrations, such as by a control plane that manages the lifecycle of VMs for an enterprise.

In an example where the internal identifier of the cloned VM has changed, stages 115-130 can be performed, and stages 135-160 can be skipped. But in an example where the internal identifier of the cloned VM has not changed, then stages 115-130 can be skipped, and the method can proceed to stages 135.

At stage 135, the first thread can determine that the internal identifier of the cloned VM has not changed. The method can then proceed to stage 140, where the first thread can set the first variable to indicate that registration was not triggered based on an internal identifier change, such as by setting s_bVMRegTriggeredByIntID=FALSE. In some examples, setting the first variable to false includes maintaining an existing state for that variable. That is, if the first variable is already set to false, then this stage can include simply maintaining that setting.

At stage 145, the first thread can check the status of the second variable to determine whether any of the cloned VM's external identifiers have changed. The second variable can be controlled by the second thread, as explained in more detail with respect to FIG. 2. To check this variable, the first thread can assert a signal on a memory bus associated with the second variable. Because the second variable is an atomic variable, it can only service one signal at a time, preventing the first thread from reading the status if the second thread is currently performing an operation. This can prevent the first thread from obtaining outdated or incorrect data while avoiding the need for a full thread lock that can be a burdensome and time-consuming process.

If, as a result of stage 145, the first thread determines that the second variable does not indicate a change in external identifiers, then the process can end as explained with respect to FIG. 2. On the other hand, if the check at stage 145 indicates that any of the cloned VM's external identifiers have changed, then the method can proceed to stage 150. Stage 150 can include determining that the second variable indicates a change, causing the method to proceed to stages 155 and 166.

At stage 155, the first thread can register the cloned VM with a backend system in the same manner described with respect to stage 125. After registration, the first thread can optionally perform stage 160, which includes setting the third variable to indicate that registration has been completed. This flag can be useful for logging or reporting registrations, such as by a control plane that manages the lifecycle of VMs for an enterprise.

The example method of FIG. 1 generally depicts a method performed by the first thread, including checking a variable set by the second thread. However, the second thread can perform various stages of a method in order to set the second variable. FIG. 2 and FIG. 2 CONT'D provide a combined flowchart that show methods that can be simultaneously performed by the first and second threads, respectively.

Turning to FIG. 2, a flowchart is shown depicting a method performed by the first thread (denoted “THREAD 1” in the drawings), with several lines showing interactions between this flowchart and the flowchart of the second thread in FIG. 2 CONT'D. These two flowcharts can be considered two separate methods or can be one combined method. At stage 210, the first thread can begin execution. This can occur when a new VM is instantiated, such as by cloning an existing VM. The first thread can be cloned as part of the VM and start executing on the cloned VM as soon as the cloned VM is instantiated.

At stage 212, the first thread can initialize at least two variables. In some examples, these variables are initialized by being inherited from a parent VM, such that the variables and their associated states are copied from a parent VM to a cloned VM, such as by storing the variable in persistent storage. But they can also be initialized by being defined or set by a first thread executing on the cloned VM. The variables initialized at stage 210 can include, for example, a first variable associated with an internal identifier of the cloned VM relative to an internal identifier of the parent VM and a second variable associated with an external identifier of the cloned VM. These variables are atomic variables because they can only be accessed or modified by a single thread at a time, avoiding multi-thread interference or redundancies. The variables can correspond to flags or counters that persist on the VM and at least provide a binary option such as “0” or “1,” or “true” or “false.” As described above, an optional third variable is available for use, but for simplicity the discussion of FIGS. 2 and 2 CONT'D will omit the third variable.

At stage 214, the first thread can begin a task that determines whether registration, or re-registration, is necessary for the cloned VM. This task can be a periodic task that is performed based on a time interval, such as every minute or every hour. In some examples, the frequency of the task is based on use, such that when the VM is idle, the task either does not run or runs less frequently than when the VM is actively being used. At stage 216, the first thread can determine whether the task should be ended. For example, the task should be ended at stage 218 when registration is complete or unnecessary. Otherwise, the method can proceed to stage 220.

At stage 220, the first thread can determine whether an internal identifier of the VM has changed. The internal identifiers can correspond to identifier stored at the VM, such as a BIOS UUID or a MAC address associated with the VM. When a VM is cloned, it can retain the BIOS UUID and MAC address of the parent VM within persistent storage. But these internal identifiers need to be reset, such as by rebooting the VM. When either (or in some examples, both) the BIOS UUID or MAC address of the VM is changed, the current value will differ from the persistently stored values used during the cloning process. At stage 220, the first thread determines whether the persistently stored values of either the BIOS UUID or MAC address differ from their current values, indicating that they have changed.

If the first thread determines at stage 220 that an internal identifier has changed, then the method proceeds to stage 222. At stage 222, the first thread can set the first variable to indicate that registration has been triggered based on an internal identifier change, such as by setting the variable to “1” or “true.” For example, the first thread can set s_bVMRegTriggeredByIntID=TRUE.

The method can then proceed to stage 224, where the first thread causes a registration process to occur. This can be referred to as a “re-registration,” because even if the parent VM was already registered, the cloned VM needs to be registered itself. As mentioned with respect to stage 125 of FIG. 1, the registration process can include registering the cloned VM with a backend service 355 of the cloud service provider 310 using known methods.

The method can then proceed to stage 228, which includes a determination that registration is complete. The first thread can then perform stage 230, which includes resetting various flags (variables) to indicate the completion of registration and to leave the variables in condition for future cloned VMs. For example, at stage 230 the first thread can set the first variable to FALSE. This way, when the VM is cloned again, the newly cloned VM will show the correct flag.

Returning to stage 220, if the first thread determines that no internal identifier has been changed, then the method can proceed to stage 226. At that stage, the first thread can check the second variable. This is shown by the dashed line extending from element 226 of FIG. 2 to element 254 of FIG. 2 CONT'D. The dashed line indicates checking the second variable by asserting a signal on the memory bus without the thread being locked. By asserting a signal in this manner, the first thread will not interrupt the second thread if it is in the process of setting the second variable.

If the second variable is set to true, indicating a change in external identity, then the method moves to stage 224 and continues as explained above. Otherwise, the method moves to stage 216 and either repeats periodically or ends at stage 218.

Moving to FIG. 2 CONT'D, a flowchart pertaining to a second thread labelled “THREAD 2” is shown. The second thread can start at stage 240 and can be a security agent executing on a VM, as described with respect to FIG. 3. The second thread can be a task that listens for a type of event. For example, the event can be a connection, or reconnection, between the relevant VM and a control plane of a virtualization platform.

At stage 242, the second thread can establish a connection between the parent VM and an external process, such as a process running on a platform. A clone of the VM can be created at stage 244, leading to the cloned VM upon which the first thread of FIG. 2 is executing. When a VM is cloned, a connection between the cloned VM and the platform must be established. This connection event can appear as re-establishing a broken connection at stage 246. However, stage 246 can include a detection of any connection event between the cloned VM and any external process. This can include detecting a connection between the VM and a platform, a control plane, or a backend system.

When a connection is detected, the second thread proceeds to stage 248, where it determines whether any external identifier has been changed. An external identifier can include a VM UUID, a platform UUID, or other VDI-provider-specific parameter that identifies a VM. When a VM is cloned, it can retain any external identifiers stored in persistent storage of the parent VM. But the platform that prompted the cloning can assign a new external identifier to the cloned VM. In that example, the external identifiers stored at the VM are different from those stored at the platform. The second thread can make this determination at stage 248 by querying the platform, such as by sending a request to the control plane described in FIG. 3. The control plane can return one or more external identifiers of the cloned VM, which the second thread can compare against the external identifiers stored at the cloned VM. If the external identifiers match, the second thread's process can end at stage 250.

If the identifier do not match, then the process can proceed to stage 252. At stage 252, the second thread checks the status of the first variable before determining how to set the second variable. This can prevent an unnecessary registration because if the first variable already indicates that registration is necessary based on a changed internal identifier, then registration will already occur on that basis—an additional registration event due to the external identifier would therefore be unnecessary. On the other hand, if the first variable does not indicate any changed internal identifier, registration is still needed based on the changed external identifier.

Thus, at stage 252 the second thread checks the status of the first variable, shown by the dashed line extending to element 226 of FIG. 2. If the first variable is not set to TRUE (i.e., the first variable indicates no registration based on internal identifier), then the second thread moves to stage 254 by setting the second variable to true. For example, the second thread can set s_bVMExtIDChanged=TRUE. The process can then end at stage 250.

If, at stage 252, the second thread determines that the first variable is set to TRUE (i.e., the first variable indicates registration is needed based on an internal identifier change), then the second thread moves to stage 256 by setting the second variable to false. For example, the second thread can set s_bVMExtIDChanged=FALSE. The process can then end at stage 258.

FIG. 3 provides an illustration of a system for efficiently registering a cloned VM according to the methods described above. The system of FIG. 3 generally includes a cloud service provider 310 and a control plane 360. The cloud service provider 310 can be any entity, such as a third-party company, that offers on-demand availability of computer system resources to customers using a cloud-based infrastructure. The computer system resources can include data storage, compute, or memory resources, or some combination thereof.

The cloud service provider 310 can also provide one or more VMs for use by a customer. In the example of FIG. 3, the cloud service provider 310 has instantiated VMs 320, 330, 340, and 350. In some examples, a cloud service provider 310 can maintain a pool of available VMs, such as 10 VMs that are already instantiated and ready for use. As a customer uses more or fewer VMs, the cloud service provider 310 can adjust the number of VMs available to maintain a target pool of available VMs. Additionally, the cloud service provider 310 can offer different types of VMs that are optimized for different uses. For example, the cloud service provider 310 can provide storage-optimized VMs that prioritize storage over other computing resources. Similarly, the cloud service provider 310 can also provide memory-optimized VMs and compute-optimized VMs, as customer demand requires. Any combination of these different types of VMs can be maintained in a VM pool for immediate use.

As shown in FIG. 3, various components are shown executing on VM 320. Although only one VM 320 is shown with these components, any VM 330, 340, 350 can include similar components. These components include a first thread 321 and second thread 322, discussed throughout the disclosure above. A thread can refer to a thread of execution of programmed instructions, such as execution of a standalone software module or process. The first and second threads 321, 322 can perform various stages of the example methods described above. For example, the partial flowchart of FIG. 2 can be performed by the first thread 321, while the partial flowchart of FIG. 2 CONT'D can be performed by the second thread 322, as described.

The VM 320 can also include a security agent 323. In some examples, either or both of the first or second threads 321, 322 are executed by the security agent 323. In one example, the security agent 323 is itself the second thread 322. The security agent 323 can handle various tasks, such as communicating with the control plane 360 and carrying out instructions received from the control plane 360.

The VM 320 can further include one or more internal identifiers 324. These internal identifiers 324 can be any identifier stored at the VM 320 that uniquely identifies the VM 320. For example, an internal identifier 324 can correspond to a BIOS UUID or a MAC address associated with the VM 320. As explained above, when a VM is instantly cloned, the new clone VM can retain one or more of the parent VM's internal identifiers for a period of time or before an event such as a reboot. A difference between the persistently stored internal identifier and current internal identifier can indicate that a VM is a clone that needs to be registered. Accordingly, the internal identifiers 324 shown in FIG. 3 can be stored within a persistent storage location associated with the VM 320.

The VM can also include multiple variables 325, which can also be stored within a persistent storage location associated with the VM 320. The variables 325 can include, for example, (1) a first variable associated with a current internal identifier 324 of the cloned VM 320 relative to a persistently stored internal identifier 324 of the cloned VM 320, (2) a second variable associated with an external identifier of the cloned VM 320, and (3) a third variable associated with registering the cloned VM 320 with a backend system 355. These variables 325 can be atomic variables that can only be accessed or modified by a single thread 321, 322 at a time, avoiding multi-thread interference or redundancies. The variables 325 can correspond to flags or counters that persist on the VM and at least provide a binary option such as “0” or “1,” or “true” or “false.”

In addition to the VMs 320, 330, 340, 350, the cloud service provider 310 can also include a backend service 355, also referred to a cloud backend. The backend service 355 can provide functionality for performing the operations required to provide the cloud service, such as managing computing hardware and associated software, including lifecycle management such as updating components, resolving conflicts, and fixing faults and failures. The backend service 355 can also be used in the registration process of a new VM. For example, if a customer instructs the cloud service provider 310 to instantiate a new VM, the new VM can be registered with the backend service 355 such that the cloud service provider 310 can execute full control over the new VM. In some examples, the backend service 355 maintains the pool of available VMs 320, 330, 340, 350. The backend service 355 can also receive instructions from a customer, such as through the control plane 360, and cause those instructions to be carried out within the cloud infrastructure.

The control plane 360 can be a platform, or portion of a platform, for managing VMs. An example of such a platform is VMWARE's VSPHERE platform. The control plane 360 can receive instructions from a customer, such as through an admin or a VDI user, and manage the cloud service provider 310 to provide service to the customer. For example, when a user launches a virtual desktop on their computing device, the computing device can request the virtual desktop from the control plane 360. The control plane 360, in turn, can instruct the cloud service provider 310 to provision a VM from the pool of available VMs.

The control plane 360 need not be specific to a single cloud service provider 310. For example, an enterprise may use two, three, or more cloud service providers 310 in different regions. When a user travels from one region to another, cloud service availability and performance can change. The control plane 360 can monitor such availability and performance, using this information to select the appropriate cloud service provider 310 for a particular user based on their current circumstances. For example, a user may utilize a virtual desktop at their home office based on a first cloud service provider 310, but while launching a virtual desktop during a vacation in another geographic region, the same user on the same device could utilize the virtual desktop through a second cloud service provider 310. The control plane 360 can manage these decisions and resource deployments.

The control plane 360 can store external identifiers for the VMs 320, 330, 340, 350 of the cloud service provider 310. The external identifiers can correspond to any identifier that uniquely identifies a VM and is assigned or stored at a location external to the VM or the cloud service provider. For example, external identifiers can include a VM UUID or platform UUID. A VM UUID can be a unique ID assigned to a VM by an entity such as the control plane 360. A platform UUID can be a UUID assigned by the control plane 360 of a platform for managing VMs. In some examples, a VM UUID and a platform UUID are the same thing, but in other examples the two identifier types can be different from one another. These identifiers, individually or collectively, can be considered an external identifier or external identity, interchangeably. A VM can persistently store an external identifier assigned during registration. A new VM cloned from that VM would then inherent the persistently stored external identifier. However, the control plane 360 can assign a new external identifier to the cloned VM, indicating that the cloned VM is a different VM than the parent. When the new external identifier of a cloned VM is different than the stored external identifier, this can indicate a need for the cloned VM to be registered.

In response to a request from the second thread 322 or security agent 323 executing on the VM 320, the control plane 360 can provide any external identifiers 362 relevant to the VM 320. The second thread 322 or security agent 323 can these compare these external identifiers 362 to any external identifiers 362 stored at the VM 320 to determine if a change has occurred. This process is explained above in more detail with respect to FIG. 2 CONT'D.

The control plane 360 can also include a lifecycle manager 364 that manages aspects of the VMs 320, 330, 340, 350 executing at the cloud service provider 310. For example, the lifecycle manager 364 can instruct the cloud service provider 310 to provision a particular type of VM, to expand or contract a pool of available VMs, to update VMs with particular software, to offer VMs in different geographical regions, and other functionalities offered by the cloud service provider 310. To perform these tasks, the lifecycle manager 364 can communicate with the backend service 355 of the cloud service provider 310 and provide appropriate instructions for carrying out the desired tasks.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for registering a cloned virtual machine (“VM”), comprising:
instantiating the cloned VM from a parent VM;
initializing two atomic variables that can be read and modified by a thread executing within the cloned VM, the variables comprising:
a first variable associated with an internal identifier of the cloned VM relative to an internal identifier of the parent VM; and
a second variable associated with an external identifier of the cloned VM;
in an instance where a first thread detects a change of the internal identifier of the cloned VM:
setting the first variable to indicate that registration was triggered based on the internal identifier; and
registering the cloned VM with the backend system; and
in an instance where a first thread detects no change of the internal identifier of the cloned VM:
setting the first variable to indicate that registration was not triggered based on the internal identifier;
checking the second variable to determine whether the external identifier of the cloned VM has changed; and
if the second variable indicates that the external identifier has changed, registering the cloned VM with the backend system.

2. The method of claim 1, wherein the second variable is set by a second thread executing within the cloned VM, based on the second thread determining that the external identifier of the cloned VM has changed.

3. The method of claim 2, wherein the second thread checks the first variable before setting the second variable.

4. The method of claim 3, wherein in an instance where the first variable indicates that registration was triggered based on the internal identifier, setting the second variable to indicate that the external identifier has not been changed.

5. The method of claim 3, wherein checking the first variable comprises asserting a signal on a memory bus without the first or second threads being locked.

6. The method of claim 1, wherein the internal identifier is at least one of a basic input/output system (“BIOS”) universally unique identifier (“UUID”) and a media access control (“MAC”) address.

7. The method of claim 1, wherein the external identity is a VM universally unique identifier (“UUID”).

8. A non-transitory, computer-readable medium containing instructions that, when executed by a hardware-based processor, cause the processor to perform stages for registering a cloned virtual machine (“VM”), the stages comprising:
instantiating the cloned VM from a parent VM;
initializing two atomic variables that can be read and modified by a thread executing within the cloned VM, the variables comprising:
a first variable associated with an internal identifier of the cloned VM relative to an internal identifier of the parent VM; and
a second variable associated with an external identifier of the cloned VM;
in an instance where a first thread detects a change of the internal identifier of the cloned VM:
setting the first variable to indicate that registration was triggered based on the internal identifier; and
registering the cloned VM with the backend system; and
in an instance where a first thread detects no change of the internal identifier of the cloned VM:
setting the first variable to indicate that registration was not triggered based on the internal identifier;
checking the second variable to determine whether the external identifier of the cloned VM has changed; and
if the second variable indicates that the external identifier has changed, registering the cloned VM with the backend system.

9. The non-transitory, computer-readable medium of claim 8, wherein the second variable is set by a second thread executing within the cloned VM, based on the second thread determining that the external identifier of the cloned VM has changed.

10. The non-transitory, computer-readable medium of claim 9, wherein the second thread checks the first variable before setting the second variable.

11. The non-transitory, computer-readable medium of claim 10, wherein in an instance where the first variable indicates that registration was triggered based on the internal identifier, setting the second variable to indicate that the external identifier has not been changed.

12. The non-transitory, computer-readable medium of claim 11, wherein checking the first variable comprises asserting a signal on a memory bus without the first or second threads being locked.

13. The non-transitory, computer-readable medium of claim 8, wherein the internal identifier is at least one of a basic input/output system (“BIOS”) universally unique identifier (“UM”) and a media access control (“MAC”) address.

14. The non-transitory, computer-readable medium of claim 8, wherein the external identity is a VM universally unique identifier (“UM”).

15. A system for registering a cloned virtual machine (“VM”), comprising:
a memory storage including a non-transitory, computer-readable medium comprising instructions; and
a computing device including a hardware-based processor that executes the instructions to carry out stages comprising:
instantiating the cloned VM from a parent VM;
initializing two atomic variables that can be read and modified by a thread executing within the cloned VM, the variables comprising:
a first variable associated with an internal identifier of the cloned VM relative to an internal identifier of the parent VM; and
a second variable associated with an external identifier of the cloned VM;
in an instance where a first thread detects a change of the internal identifier of the cloned VM:
setting the first variable to indicate that registration was triggered based on the internal identifier; and
registering the cloned VM with the backend system; and
in an instance where a first thread detects no change of the internal identifier of the cloned VM:
setting the first variable to indicate that registration was not triggered based on the internal identifier;
checking the second variable to determine whether the external identifier of the cloned VM has changed; and
if the second variable indicates that the external identifier has changed, registering the cloned VM with the backend system.

16. The system of claim 15, wherein the second variable is set by a second thread executing within the cloned VM, based on the second thread determining that the external identifier of the cloned VM has changed.

17. The system of claim 16, wherein the second thread checks the first variable before setting the second variable.

18. The system of claim 17, wherein in an instance where the first variable indicates that registration was triggered based on the internal identifier, setting the second variable to indicate that the external identifier has not been changed.

19. The system of claim 17, wherein checking the first variable comprises asserting a signal on a memory bus without the first or second threads being locked.

20. The system of claim 15, wherein the internal identifier is at least one of a basic input/output system (“BIOS”) universally unique identifier (“UUID”) and a media access control (“MAC”) address.
